(19) United States
(12) Patent Application Publication
(10) Pub. No.: US 2026/0050962 A1
(43) Pub. Date: Feb. 19, 2026

(54) THIRD PARTY CONTENT ITEM BID REQUESTS WITH CONTENT ITEM RECOMMENDATIONS

(71) Applicant: Pinterest, Inc., San Francisco, CA (US)

(72) Inventors: Dinesh Govindaraj, Sammamish, WA (US); Philip Edward Price, Seattle, WA (US); Scott Collins, Seattle, WA (US); Daniel Kang, Studio City, CA (US)

(73) Assignee: Pinterest, Inc., San Francisco, CA (US)

(21) Appl. No.: 18/807,685

(22) Filed: Aug. 16, 2024

(51) Int. Cl. G06Q 30/0601; G06Q 30/08

(52) U.S. Cl. CPC G06Q 30/0631; G06Q 30/08

(57) ABSTRACT

Described are systems and methods to determine a content item recommendation that is included in a content item bid request, recommending to a third party, a third party content item to include in a content item bid that is responsive to the bid request. The content item recommendation may indicate a particular third party product or third party content item that is predicted to perform well in a content item slot and for a specific user without disclosing user information to the third party.

### BACKGROUND

The presentation of content in online platforms and through applications continues to change and become more personalized. As a result, individuals to which content is presented expect the content to be relevant to both their preferences and their current session. Because of the ubiquitous nature of online content, the effectiveness and/or value of content items that are selected and presented can sometimes be questionable as to whether the content items will be relevant to the user and/or the user's current session. The ineffectiveness of presented content items can also be magnified if unrelated and/or irrelevant content items are presented along with other content items that are relevant to the user.

### BRIEF DESCRIPTION OF THE DRAWINGS

FIG. 1 is an illustration of an exemplary computing environment, according to exemplary implementations of the present disclosure.

FIGS. 2A and 2B are illustrations of exemplary user interfaces, according to exemplary implementations of the present disclosure.

FIG. 3 is an example third party item index generation process, according to exemplary implementations of the present disclosure.

FIG. 4 is an example candidate content item list generation process, according to implementations of the present disclosure.

FIG. 5 is a block diagram of an exemplary content item recommendation determination model, according to exemplary implementations of the present disclosure.

FIG. 6 is a flow diagram of an exemplary machine learning model training process, according to exemplary implementations of the present disclosure.

FIG. 7 is a flow diagram of an exemplary content item recommendation determination process, according to exemplary implementations of the present disclosure.

FIG. 8 is a flow diagram of an exemplary trained machine learning model update process, according to exemplary implementations of the present disclosure.

FIG. 9 is an illustration of an exemplary client device, according to exemplary implementations of the present disclosure.

FIG. 10 is an illustration of an exemplary configuration of a client device, such as that illustrated in FIG. 9, according to exemplary implementations of the present disclosure.

FIG. 11 is an illustration of an exemplary remote computing resource, according to exemplary implementations of the present disclosure.

### DETAILED DESCRIPTION

In typical content item bidding and placement, when a user visits a page in which content items are to be presented to the user, the publisher, also referred to herein as a content management system, generates a bid request for content items and sends that bid request to content item networks, content item exchanges, demand side platforms (“DSP”), retail businesses, or any other third party that may desire to bid on placement of a third party content item, each entity generally referred to herein as a third party content provider or third party. While information included in a bid request may vary, traditionally, bid requests include a bid identifier, page information, and user information. A “page,” as used herein may include, for example, a website, an application, or any other structure that includes one or more content item slots in which content items may be included for presentation and that may be presented (visually, audibly, haptically, etc.), in whole or in part to a user.

Page information may include, for example, information about the page, the portion(s) of the page accessed or to be presented to the user, the number of content item slots available within the page, content information about other content items to be presented on the page, etc. User information may include, for example, the user's device type, Internet Protocol (“IP”) address, cookies, tags, pixels, user demographics, browsing history, and/or other user specific information, generally referred to herein as user information. Third parties, in response to a bid request, select one or more third party content items based on, among other things, the user information and/or page information, and submit bids in real-time or near real-time for the third party content item(s) to be placed in content item slots of the page and presented to the user. The publisher then selects, based on the returned bids, one or more third party content items for presentation to the user in the available content item slot(s) and presents the third party content items to the user in those content item slots as part of a presentation of the page.

A third party content item, as used herein, may be any content that a third party desires or references in a bid to have presented in a content item slot and presented as part of a page to a user. For example, a third party content item may be a content item that indicates a product or service for sale, an image or video of a product or service, an audio file, etc. Third party content items may be provided by the third party in response to a bid request, the third party winning a bid, and/or may already be stored and/or maintained in memory by the content management system.

There is an increasing need to share less user information about the user with third parties which makes submitting bids for third party content items that are relevant to a user more difficult. In particular, without user information in a bid request, it is difficult for third parties to determine and submit bids for third party content items that are relevant to the user. Such uncertainty often results in lower returns (e.g., click-through rage, view rate, share rate, like rate, purchase) on the selected and published third party content items because the third party content items may not be relevant to the user and may decrease user satisfaction in the publisher page because the user is presented less or non-relevant content.

As discussed further below, implementations of the present disclosure resolve these problems by reducing or eliminating the sharing of user information with third parties while, at the same time, providing third parties with clear guidance on the third party content item(s) of that third party that are relevant to the user and/or the user session and should be considered or used when responding to the bid request.

For example, a content management system may determine third party content items as part of a bid request and include additional metadata, referred to herein as a “content item recommendation,” in the bid request indicating to the third party one or more third party content items that are specific to that third party that the third party should consider when selecting one or more third party content items to indicate in a bid that is responsive to the bid request. In some examples, the content item recommendation may indicate a specific third party content item, a specific product (e.g., using a product identifier) of the third party, and/or other information that is specific to the third party that the third party should consider when selecting a third party content item to include in a bid responsive to the bid request.

The third party, in response to the bid request with the content item recommendation may select, based on the content item recommendation, one or more third party content items to indicate in the bid that is submitted in response to the bid request. In some examples, the third party may select the specific third party content item indicated in the content item recommendation. In other examples, the third party may utilize the content item recommendation to select a different third party content item to include in the bid submitted in response to the bid request.

For ease of discussion, the examples utilized herein will focus on the content item recommendation included in a bid request being in the form of a product identifier of a product offered by the third party. However, as discussed above, it will be appreciated that the content item recommendation included in a bid request is not limited to specific product identifiers and may include other identifiers, such as specific third party content item identifiers for third party content items, and/or other non-user identifying information that is specific to the third party receiving the bid request and that may be utilized by that third party to select a third party content item for which a bid is returned in response to a bid request.

As a specific yet non-limiting example, as discussed further below, the content management system may maintain a third party item index that includes information for a plurality of third party items, in this example product identifiers, that are known to the content management system and specific to a third party. As noted above, while the examples herein focus on the third party items being products offered by the third party, in other implementations, the third party items may include products, third party content items, services, etc., of the third party that are known to the content management system and specific to that third party.

When the content management system determines that a bid request is to be sent out to receive bids for a content item slot in which a third party content item is to be published to a user, the content management system may utilize user information that the user has allowed the content management system to collect, such as a user account the user maintains with the content management system, user browse history with the content management system, user preferences, etc., and/or information about a page that includes the content item slot (e.g., other content presented on the page, position of the page within an application, website, etc.), and/or other information to determine an item(s) from the third party item index and generate a content item recommendation that is specific to the third party and included in the bid request sent to that third party. In some implementations, the content management system may generate different bid requests for the same content item slot that are sent to different third parties, each bid request with one or more content item recommendations that are specific to the receiving third party. Each of the third parties, in response to the bid requests, may independently determine one or more third party content items and submit a bid for those one or more third party content items in response to the bid request. Finally, upon receiving the bids from the different third parties, the content management system may select and present a third party content item corresponding to a winning bid to the user in the content item slot.

Because the content management system is sending bid requests to different third parties with content item recommendations specific to those third parties, the third parties can select highly relevant and targeted third party content items for bidding without knowing user information about the user to whom the third party content item may be shown, thereby preserving user anonymity and limiting the sharing of user information with third parties while at the same time increasing content item conversion and user satisfaction because the user is presented with third party content items relevant to that user and the current user session.

According to exemplary implementations of the present disclosure, one or more artificial intelligence systems (“AI system”), such as a machine learning model, may be trained to process various input information and parameters to determine relevance scores for candidate content item recommendations, such items indicated in a third party item index. For example, the trained AI system may include two independent components/towers within the trained AI system. The first component/tower of the AI system may be trained to process general quality information and/or parameters, such as user history, a query, and the like, to generate a candidate quality relevance score associated for each candidate content item recommendation, such as third party items indicated in the third party item index. The second component/tower of the AI system may be trained to process local contextual information, such as a predefined content item slot (e.g., slot index, column, etc.), surrounding content items, surrounding other third party content items, content item format, and the like, to generate a candidate contextual relevance score associated with each candidate content item recommendation. The candidate quality relevance score and the candidate contextual relevance score may be aggregated to determine an overall candidate engagement score, which may represent an overall relevance of the candidate content item recommendation (e.g., likelihood that the user will interact or otherwise engage with a third party content item selected and presented based on the content item recommendation, etc.).

Accordingly, the content management system may determine a content item recommendation from the candidate content item recommendations to include or indicate in a bid request that is sent to a third party based on the associated overall candidate engagement scores. For example, the candidate content item recommendations for a third party may be ranked according to their associated overall candidate engagement scores and the candidate content item recommendation(s) with the highest overall candidate engagement score(s) may be indicated in a bid request that is sent to a third party. In other examples, a bid amount for the third party may be determined that would result in a third party content item selected in response to a candidate content item recommendation being selected for placement at the content item slot and/or a bid amount that would optimize for a target return on third party content item spend and one or more of those factors may be used alone or in combination with other factors to rank candidate content item recommendations that are sent to a third party as part of a bid request that is specific to that third party.

According to exemplary implementations of the present disclosure, co-training a single AI system with two independent components/towers simplifies training, development, and maintenance of the AI system. Further, in view of the two independent components/towers, the input information and parameters may be served and processed in parallel, so as to mitigate the introduction of additional latency. Further, exemplary implementations may also utilize cached content items as an approximation of contextual content to further mitigate latency issues that may result from using actual contextual content.

Additionally, after the content item recommendations have been determined and sent to a third party as part of a bid request, bids returned, and winning third party content items presented to the user (e.g., at the predefined content item slots), the performance of the presented third party content items at the predefined content item slots may be tracked. For example, click through rates associated with each third party content item may be determined, and based on the click through rates, feedback training data may be generated to continuously update the trained AI system(s) to improve the performance and accuracy of the trained AI system(s).

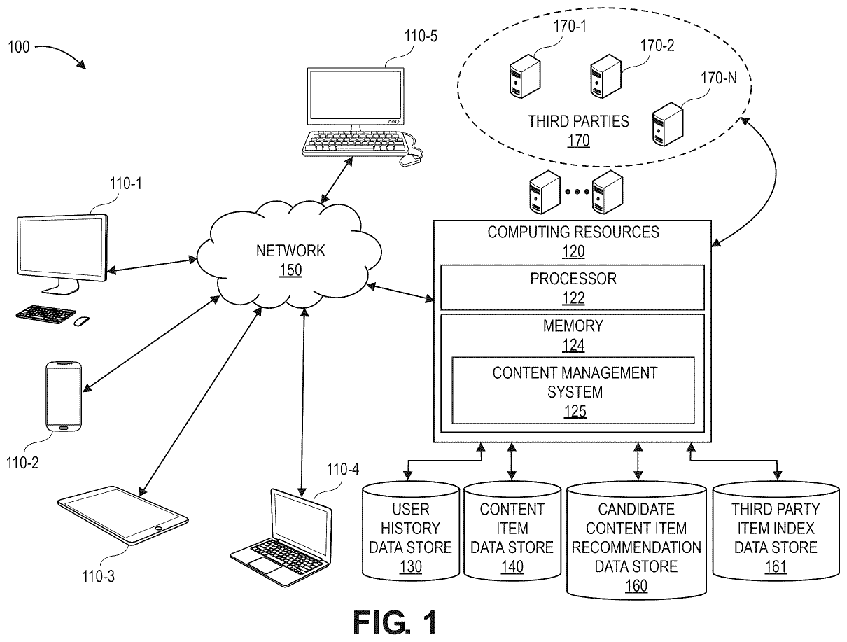

FIG. 1 is an illustration of an exemplary computing environment 100, according to exemplary implementations of the present disclosure.

As shown in FIG. 1, computing environment 100 may include one or more client devices 110 (e.g., client devices 110-1, 110-2, 110-3, 110-4, and 110-5), remote computing resources 120, a content management system 125, which may execute on remote computing resources 120, and one or more third parties 170-1, 170-2, through 170-N that may be independent and separate from the computing resources 120 and the content management system 125.

Remote computing resources 120 may include one or more processors 122 and one or more memory 124. Further, remote computing resources 120 may also include one or more applications, such as a content management system 125, that may be executed by processor(s) 122 to cause the processor(s) 122 of remote computing resources 120 to perform various functions and/or actions. The content management system 125 may include one or more artificial intelligence (“AI”) systems, such as machine learning models, large language models (“LLM”), etc., that have been trained to determine content item recommendations to include in bid requests that are sent to third parties 125, determine one or more third party content items to present to the user (winning bids), as well as relative positioning of the third party content items to be presented to a user on any of client devices 110-1, 110-2, 110-3, 110-4, and/or 110-5. In other implementations, portions of the disclosed implementations may be performed on client devices 110-1, 110-2, 110-3, 110-4, and 110-5.

As will be appreciated, any variation of processing and/or other operations of the disclosed implementations may be performed on one or many different devices. Likewise, the disclosed implementations, may, for example, be provided as part of a social networking environment, e-commerce environment, or any other form of interactive computing. Further, remote computing resources 120 do not require end-user knowledge of the physical location and configuration of the system that delivers the services. Common expressions associated with these remote computing resources 120 include, for example, “on-demand computing,” “software as a service (SaaS),” “platform computing,” “network-accessible platform,” “cloud services,”“data centers,”and so forth.

Each client device 110-1, 110-2, 110-3, 110-4 and 110-5, remote computing resources 120, and the third parties 170 may communicate via wired and/or wireless connections to network 150. Client devices 110-1, 110-2, 110-3, 110-4 and/or 110-5 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client devices 110-1, 110-2, 110-3, 110-4 and 110-5 and remote computing resources 120 (and content management system 125 executing thereon). Likewise, the third parties 170 may operate on one or more computing resources that are capable of communicating with the computing resources 120.

Further, the content management system 125 may be configured to be in communication with user history data store 130, content item data store 140, candidate content item recommendation data store 160, and the third party item index data store 161. User history data store 130 may be configured to store and maintain information associated with one or more users associated with client devices 110-1, 110-2, 110-3, 110-4 and/or 110-5. For example, this can include information relating to the user's profile and/or history (e.g., demographic information, user preferences, level of activity, type of activity, content items associated with the user, queries associated with the user, subscriptions, purchase history, click through history, etc.). Additionally, content item data store 140 may be configured to store and maintain various content items (e.g., images, videos, etc.), candidate content item recommendation data store 160 may be configured to store and maintain candidate content item recommendations that are available to be presented to the user on client devices 110-1, 110-2, 110-3, 110-4 and/or 110-5, and the third party item index data store 161 may be configured to store and maintain an index of third party items that are either available to be presented on the user devices from the content item data store or the candidate content item data store, and/or potentially obtainable from a third party, as discussed further below. In some implementations, additional item information for each third party item indicated in the third party item index data store 161 may also be maintained in the data store 161 and/or other data store or memory of the computing resources 120. Additional item information may include, but is not limited to product information, pricing, size, delivery options, sales, ratings, website or page address of the third party corresponding to the item, title of the item, etc. Such additional item information may be provided by the third party, obtained from public information accessible from the third party, such as by crawling or processing the third parties website, submitted by the user and/or other users accessing the computing resources 120 and the services offered by the computing resources (e.g., e-commerce, social networking, etc.). As discussed herein, such information may be utilized to determine content item recommendations for inclusion in a bid request to the third party.

According to exemplary implementations of the present disclosure, client devices 110-1, 110-2, 110-3, 110-4 and/or 110-5 may access and/or interact with content management system 125 through network 150 via one or more applications operating and/or executing on client devices 110-1, 110-2, 110-3, 110-4 and/or 110-5. In exemplary implementations, users associated with client devices 110-1, 110-2, 110-3, 110-4, and/or 110-5 may be navigating, viewing, accessing, and/or otherwise consuming content items on client devices 110-1, 110-2, 110-3, 110-4, and/or 110-5 as part of a social media platform or environment, a networking platform or environment, an e-commerce platform or environment, by performing queries, or through any other form of interactive computing. In connection with the consumption of content items on client devices 110-1, 110-2, 110-3, 110-4, and/or 110-5, a request for one or more content items, such as a third party content item, may accompany or be included in the user's navigation and/or consumption of content items so that third party content items may be selected and presented alongside the content items. The user interfaces presenting the third party content items and other content items may include one or more predefined content item slots (e.g., defined by slot and/or column, etc.) at which content items may be presented. Accordingly, the selected third party content items may be presented to users via user interface(s) presented on client devices 110-1, 110-2, 110-3, 110-4, and/or 110-5 at the predefined content item slots during consumption of the page.

In response to the request for one or more third party content items, content management system 125 may obtain various information and parameters (e.g., from user history data store 130, content item data store 140, etc.) associated with the user and the user's activities and determine for each of one or more third parties one or more candidate content item recommendations (e.g., from third party item index data store 161) to include in a bid request sent to each of those third parties 170. According to exemplary implementations, the obtained information and parameters may include general quality information and/or parameters, such as user history, a query, and the like, and local contextual information and/or parameters, such as a content item slot (e.g., slot index, column, etc.), surrounding content items, surrounding other third party content items, content item format, and the like. The general quality of information and/or parameters may be processed by content management system 125 to generate a candidate quality relevance score for each candidate content item recommendation, and the local contextual information may be processed by content management system 125 to determine a candidate contextual relevance score for each candidate content item recommendation. As a result, for the one or more third parties 170 to which a bid request is to be sent, one or more content item recommendations may be determined from the candidate content item recommendations for that third party and included in the bid request sent to that third party 170. Each of the third parties 170, in response to the bid requests may determine, based at least in part on the included content item recommendations, one or more third party content items and submit a bid to have the third party content item(s) presented to the user in the respective content item slots.

According to exemplary implementations of the present disclosure, content management system 125 may include one or more trained AI systems to process the obtained information and parameters to determine the one or more content item recommendations to be included in a bid request sent to a third party. The trained AI system may include two independent components/towers, where the first component/tower is configured to process the general quality information and/or parameters to determine a candidate quality relevance score associated with each candidate content item recommendation for the third party, and the second component/tower of the AI system is configured to process the local contextual information and/or parameters to determine a candidate contextual relevance score for each candidate content item recommendation for that third party. According to certain aspects, determination of the candidate quality relevance score and the candidate contextual relevance score may be determined in parallel.

Next, for each candidate content item recommendation for the third party, an overall candidate engagement score may be determined based on the candidate quality relevance score and the candidate contextual relevance score. For example, the overall candidate engagement score may be determined using a sigmoid function on the aggregation of the candidate quality relevance score and the candidate contextual relevance score.

Accordingly, the overall candidate engagement score may be represented as:

Overall Engagement Score=Sigmoid (Candidate_Quality+Candidate_Context)

where Candidate_Quality may represent the candidate quality relevance score and Candidate_Context may represent the candidate contextual relevance score. After the overall candidate engagement score has been determined, the content item recommendation(s) to include in the bid request for that third party may be determined based on the overall candidate engagement scores associated with each candidate content item recommendation. For example, the candidate content item recommendation with the highest overall candidate engagement score for each predefined content item slot may be selected and included as a content item recommendation in a bid request that is sent to a third party. The third parties may submit bids for different third party content items and the content management system 125 selects winning bid(s) and determines/presents third party content items corresponding to the winning bids in the different content item slots. Further, the performance of each selected and presented third party content item may be monitored (e.g., click-through rate, etc.) and feedback training data may be generated based on the actual monitored performance to further update and improve the performance of the AI system.

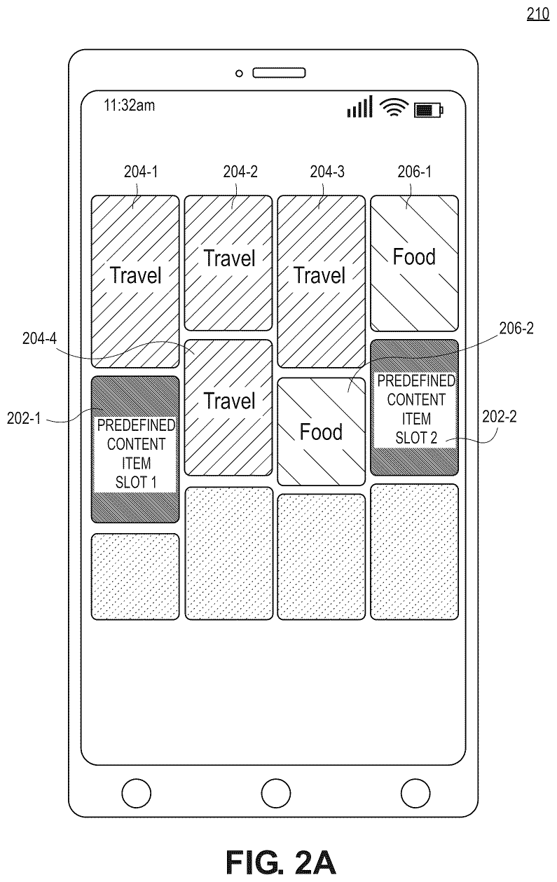

FIGS. 2A and 2B illustrate exemplary user interfaces presenting content items and third party content items, according to exemplary implementations of the present disclosure.

FIG. 2A is a block diagram illustration of exemplary user interface 200, according to exemplary implementations of the present disclosure. User interface 200 may represent a user interface presented to users on client devices (e.g., client devices 110-1, 110-2, 110-3, 110-4, and/or 110-5) as users are navigating, viewing, accessing, and/or otherwise consuming content items as part of a social media platform or environment, a networking platform or environment, an e-commerce platform or environment, by performing queries, or through any other form of interactive computing.

As shown in FIG. 2A, user interface 200 may include content items 204-1, 204-2, 204-3, 204-4, 206-1, and 206-2. Content items 204-1, 204-2, 204-3, 204-4, 206-1, and 206-2 may be content items accessible directly through or from the content management system, such as content items provided by other users, content items provided by other third parties, content items generated by the content management system, etc., and may be presented on user interface 200 for the user to view, access, or otherwise consume, in response to a query provided by the user, and the like. Additionally, user interface 200 may also include predefined content item slots 202-1 and 202-2, at which third party content items are selected and presented according to exemplary implementations of the present disclosure.

Exemplary implementations of the present disclosure may generate bid requests that include content item recommendations specific to each third party receiving the bid request, receive bids from the third parties, select winning bids, and present third party content items corresponding to the winning bids at the predefined content item slots 202-1 and 202-2. In determining the content item recommendations to be included in bid requests, various inputs may be provided to a trained AI system (e.g., content management system 125) to predict an overall candidate engagement score, which can be used to determine the content item recommendation(s) to be included in the bid request sent to different third parties to bid for third party content items to be presented at predefined content item slots 202-1 and 202-2.

For example, candidate quality parameters and candidate contextual parameters may be provided as inputs to the trained AI system to predict overall candidate engagement scores for each candidate content item recommendation for a third party. The candidate quality parameters may include information such as a query submitted by the user, user profile information, user preferences, user browsing history, user tastes, user likes/dislikes, content items associated with the user, demographic information, user activity, user subscriptions, queries performed by the user, and the like, and be provided as an input to a first independent component/tower of the trained AI system. The first component/tower of the trained AI system can process the candidate quality parameters to generate a predicted candidate quality relevance score for each candidate content item recommendation. The predicted candidate quality relevance score may represent a predicted click-through rate, revenue per recipient, or other metric based on the user information.

Additionally, the candidate contextual parameters may include information such as the position of the content item to be presented (e.g., predefined content item slots 202-1 and/or 202-2.), information regarding the content items surrounding and/or in close proximity of the third party content item to be presented, information regarding other third party content items surrounding and/or in close proximity of the third party content item to be presented, information regarding the content of the candidate content item recommendation, and the like, and be provided as an input to a second independent component/tower of the trained AI system. The second component/tower of the trained AI system can process the candidate contextual parameters to generate a predicted candidate contextual relevance score for each candidate content item recommendation. The predicted candidate contextual relevance score may represent a predicted click-through rate, revenue per recipient, or other metric based on the localized contextual information.

In the exemplary implementation illustrated in FIG. 2A, in connection with predefined content item slot 202-1, the candidate contextual parameters provided to the trained AI system may include information associated with content items 204-1, 204-2, 204-3, 204-4, 206-1, and/or 206-2 which surround and/or are in close proximity to predefined content item slot 202-1, information associated with a third party content item presented at predefined content item slot 202-2, and the like. Candidate contextual parameters may also include information associated with each candidate content item recommendation, such as content information, format information (e.g., a logo content item, a price drop/sale content item, a flickering content item, etc.), and the like. For example, the candidate contextual parameters may include one or more embedding vectors associated with each content item 204-1, 204-2, 204-3, 204-4, 206-1, and/or 206-2 which may represent certain aspects (e.g., content type, content category, image information, source/location information, content/image features, metadata associated with the content item, etc.) of each corresponding content item 204-1, 204-2, 204-3, 204-4, 206-1, and/or 206-2 and one or more embedding vectors associated with the third party content item presented at predefined content item slot 202-2, which may represent certain aspects (e.g., content item type, content item category, content item format, content item image information, source/location information, content item/image features, metadata associated with the content item, etc.) of the third party content item presented at predefined content item slot 202-2. Further, the candidate contextual parameters may also include embedding vectors associated with each candidate content item recommendation, which may represent certain aspects or additional item information about each candidate content item recommendation (e.g., content type, content category, image information, source/location information, metadata associated with the content item recommendation, etc.) of each corresponding candidate content item recommendation. According to certain aspects of the present disclosure, the embedding vectors associated with content items 204-1, 204-2, 204-3, 204-4, 206-1, and/or 206-2 and/or the third party content item presented at predefined content item slot 202-2 may be compared with the embedding vectors of each candidate content item recommendation to determine a similarity metric between the surrounding content items (e.g., content items 204-1, 204-2, 204-3, 204-4, 206-1, and/or 206-2) and/or the third party content item presented at predefined content item slot 202-2 and each candidate content item recommendation. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained AI system to determine a predicted candidate contextual relevance score associated with each candidate content item recommendation.

Similarly, in connection with predefined content item slot 202-2 illustrated in FIG. 2A, the candidate contextual parameters provided to the trained AI system may include information associated with content items 206-1 and/or 206-2, which surround and/or are in close proximity to predefined content item slot 202-2, information associated with a third party content item presented at predefined content item slot 202-1, and the like. Candidate contextual parameters may also include information associated with each candidate content item recommendation, such as content information, format information, and the like. For example, the candidate contextual parameters may include one or more embedding vectors associated with each content item 206-1 and/or 206-2, which may represent certain aspects (e.g., content type, content category, image information, source/location information, content/image features, metadata associated with the content item, etc.) of each corresponding content item 206-1 and/or 206-2, one or more embedding vectors associated with the third party content item presented at predefined content item slot 202-1, which may represent certain aspects (e.g., content item type, content item category, content item format, content item image information, source/location information, content item/image features, metadata associated with the content item, etc.) of the third party content item presented at predefined content item slot 202-1. Further, the candidate contextual parameters may also include embedding vectors associated with each candidate content item recommendation, which may represent certain aspects or additional item information (e.g., content type, content category, image information, source/location information, metadata associated with the content item, etc.) of each corresponding candidate content item recommendation. According to certain aspects of the present disclosure, the embedding vectors associated with content items 206-1 and/or 206-2 and/or the third party content item presented at predefined content item slot 202-1 may be compared with the embedding vectors of each candidate content item recommendation to determine a similarity metric between the surrounding content items (e.g., content items 206-1 and/or 206-2) and/or the third party content item presented at predefined content item slot 202-1 and each candidate content item recommendation. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained AI system to determine a predicted candidate contextual relevance score associated with each candidate content item recommendation.

After the predicted candidate quality relevance score and the predicted candidate contextual relevance score have been determined, the two relevance scores may be combined and/or aggregated to determine a predicted overall candidate engagement score for each candidate content item recommendation for each predefined content item slot 202-1 and 202-2. For example, a Sigmoid function may be applied to the combination of the predicted candidate quality relevance score and the predicted candidate contextual relevance score to determine the predicted overall candidate engagement score for each candidate content item recommendation. The predicted overall candidate engagement score may represent a relevance of the candidate content item recommendation and/or a likelihood that a user will engage with a third party content item selected based on the candidate content item recommendation, and may include, for example, a predicted click-through rate, revenue per recipient, or other metric based on both the content item quality information and the localized contextual information. Accordingly, the candidate content item recommendation with the highest predicted overall candidate engagement score for predefined content item slot 202-1 may be selected as the content item recommendation for the predefined content item slot 202-1 that is included in the bid request and sent to a third party for the predefined content item slot 202-1, and the candidate content item recommendation with the highest predicted overall candidate engagement score for predefined content item slot 202-2 may be selected as the content item recommendation included in the bid request sent to the third party for requesting a bid for the predefined content item slot 202-2.

FIG. 2B is an illustration of an exemplary user interface presenting content items determined and presented according to exemplary implementations of the present disclosure.

As shown in FIG. 2B, user interface 220 may include content items 222-1, 222-2, 222-3, 222-4, 222-5, and 222-6 and third party content items 224-1 and 224-2. Content items 222-1, 222-2, 222-3, 222-4, 222-5, and 222-6 are content items directly accessible by the content management system which may be presented on user interface 220 for the user to view, access, or otherwise consume, in response to a query provided by the user, and the like. Additionally, third party content items 224-1 and 224-2 may be third party content items selected from winning bids from third parties in response to bid requests that included content item recommendations specific to the third party receiving the bid request, according to exemplary implementations of the present disclosure.

In the exemplary implementation illustrated in FIG. 2B, the content item recommendations sent to third parties that resulted in winning bids for the presented third party content items 224-1 and 224-2 may have been determined and selected from a plurality of candidate content item recommendations corresponding to that third party using a trained AI system (e.g., content management system 125).

For example, candidate quality parameters and candidate contextual parameters may have been provided as inputs to the trained AI system to predict overall candidate engagement scores for each of a plurality of candidate content item recommendations determined from a third party item index data store 161 in selecting and determining content item recommendations sent to third parties as part of a bid request that resulted in the winning bids and presentation of third party content items 224-1 and 224-2 to the user. The candidate quality parameters may include information such as a query submitted by the user, user profile information, user preferences, user browsing history, user tastes, user likes/dislikes, content items associated with the user, demographic information, user activity, user subscriptions, queries performed by the user, and the like, and be provided as an input to a first independent component/tower of the trained AI system. The first component/tower of the trained AI system can process the candidate quality parameters to generate a predicted candidate quality relevance score for each candidate content item recommendation. The predicted candidate quality relevance score may represent a predicted click-through rate, revenue per recipient, or other metric based on the user information.

Additionally, the candidate contextual parameters may include information such as the position of the content item slot at which the third party content item is to be presented, information regarding the content items surrounding and/or in close proximity of the content item slot at which the third party content item is to be presented, information regarding the content of the candidate content item recommendation, and the like, and be provided as an input to a second independent component/tower of the trained AI system. The second component/tower of the trained AI system can process the candidate contextual parameters to generate a predicted candidate contextual relevance score for each candidate content item recommendation. The predicted candidate contextual relevance score may represent a predicted click-through rate, revenue per recipient, or other metric based on the localized contextual information.

In the exemplary implementation illustrated in FIG. 2B, in connection with third party content item 224-1, the candidate contextual parameters provided to the trained AI system may have included information associated with content items 222-1, 222-2, and/or 222-3, which surround and/or are in close proximity to content item 224-1, information associated with third party content item 224-2, and the like. As illustrated in the FIG. 2B, content items 222-1, 222-2, and/or 222-3 may relate to shoes, and the content item recommendation included in the bid request that resulted in a winning bid with third party content item 224-1, may have been selected based on contextual information associated with content items 222-1, 222-2, and/or 222-3. According to certain aspects, rather than obtain candidate contextual parameters and information associated with the actual content items, cached content items may be utilized as an approximation of content items 222-1, 222-2, and/or 222-3, and the candidate contextual parameters provided to the trained AI system may have included information associated with the cached content items.

Candidate contextual parameters may also include information associated with each candidate content item recommendation, such as content information, format information, and the like. For example, the candidate contextual parameters may include one or more embedding vectors associated with each content item 222-1, 222-2, and/or 222-3 (or a cached approximation thereof), which may represent certain aspects (e.g., content type, content category, image information, source/location information, content/image features, metadata associated with the content item, etc.) of each corresponding content item 222-1, 222-2, and/or 222-3 (or a cached approximation thereof), one or more embedding vectors associated with candidate content item recommendation that resulted in a winning bid corresponding to third party content item 224-2, which may represent certain aspects (e.g., content item type, content item category, content item format, content item image information, source/location information, content item/image features, metadata associated with the content item, etc.). Further, the candidate contextual parameters may also include embedding vectors associated with each candidate content item recommendation, which may represent certain aspects (e.g., content type, content category, image information, source/location information, metadata associated with the content item, etc.) of each corresponding candidate content item recommendation. According to certain aspects of the present disclosure, the embedding vectors associated with content items 222-1, 222-2, and/or 222-3 (or cached approximations thereof) and/or candidate content item recommendation may have been compared with the embedding vectors of each candidate content item recommendation to determine a similarity metric between the surrounding content items (e.g., content items 222-1, 222-2, and/or 222-3, or cached approximations thereof) and/or each candidate content item recommendation. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained AI system to determine a predicted candidate contextual relevance score associated with each candidate content item recommendation.

Similarly, in connection with content item recommendation included in the bid request that resulted in third party content item 224-2 being selected and presented, the candidate contextual parameters provided to the trained AI system may have included information associated with content items 222-4, 222-5, and/or 222-6, which surround and/or are in close proximity to the content item position for third party content item 224-2, information associated with content item recommendation included in the bid request, and the like. As illustrated in the FIG. 2B, content items 222-4, 222-5, and/or 222-6 may relate to food, and content item recommendation included in the bid request that resulted in the selection and presentation of third party content item 224-2, which may have been selected based on contextual information associated with content items 222-4, 222-5, and/or 222-6, may also relate to food. According to certain aspects, rather than obtain candidate contextual parameters and information associated with the actual content items, cached content items may be utilized as an approximation of content items 222-4, 222-5, and/or 222-6, and the candidate contextual parameters provided to the trained AI system may have included information associated with the cached content items.

Candidate contextual parameters may also include information associated with each candidate content item recommendation, such as content information, format information, and the like. For example, the candidate contextual parameters may include one or more embedding vectors associated with each content item 222-4, 222-5, and/or 222-6 (or a cached approximation thereof), which may represent certain aspects (e.g., content type, content category, image information, source/location information, content/image features, metadata associated with the content item, etc.) of each corresponding content item 222-4, 222-5, and/or 222-6 (or a cached approximation thereof), one or more embedding vectors associated with the content item recommendation included in the bid request that resulted in the selection and presentation of third party content item 224-2, which may represent certain aspects (e.g., content item type, content item category, content item format, content item image information, source/location information, content item/image features, metadata associated with the content item, etc.) of the content item recommendation that was used to select third party content item 224-2. Further, the candidate contextual parameters may also include embedding vectors associated with each candidate content item recommendation, which may represent certain aspects (e.g., content type, content category, image information, source/location information, metadata associated with the content item, etc.) of each corresponding candidate content item recommendation. According to certain aspects of the present disclosure, the embedding vectors associated with content items 222-4, 222-5, and/or 222-6 (or cached approximations thereof) and/or content item recommendation that resulted in the selection of third party content item 224-2 may be compared with the embedding vectors of each candidate content item recommendation to determine a similarity metric between the surrounding content items (e.g., content items 222-4, 222-5, and/or 222-6, or cached approximations thereof) and/or content item 224-2 and each candidate content item recommendation. For example, the similarity metric may be determined (e.g., averaging the vectors, utilizing a max pooling algorithm, utilizing a cosine similarity algorithm, utilizing a clustering algorithm, etc.), and the similarity metric may be provided as an input to the second component/tower of the trained AI system to determine a predicted candidate contextual relevance score associated with each candidate content item recommendation.

After the predicted candidate quality relevance score and the predicted candidate contextual relevance score may have been determined, the two relevance scores may be combined and/or aggregated to determine a predicted overall candidate engagement score for determining and/or selecting a content item recommendation to include in the bid requests that resulted in the selection and presentation of third party content items 224-1 and 224-2. For example, a Sigmoid function may have been applied to the combination of the predicted candidate quality relevance score and the predicted candidate contextual relevance score to determine the predicted overall candidate engagement score for each third party content item that may be selected and presented based on each candidate content item recommendation. The predicted overall candidate engagement score may represent a relevance of the third party content item selected based on the content item recommendation and/or a likelihood that the user will engage with the third party content item, and may include a predicted click-through rate, revenue per recipient, or other metric based on both the content item quality information and the localized contextual information. Accordingly, content item recommendations included in the bid request that resulted in the selection of third party content item 224-1 may correspond to the candidate content item recommendation with the highest predicted overall candidate engagement score for the content item slot at which third party content item 224-1 is presented, and content item recommendations that result in the selection of third party content item 224-2 may correspond to the candidate content item recommendation with the highest predicted overall candidate engagement score for the content item slot at which third party content item 224-2 is presented.

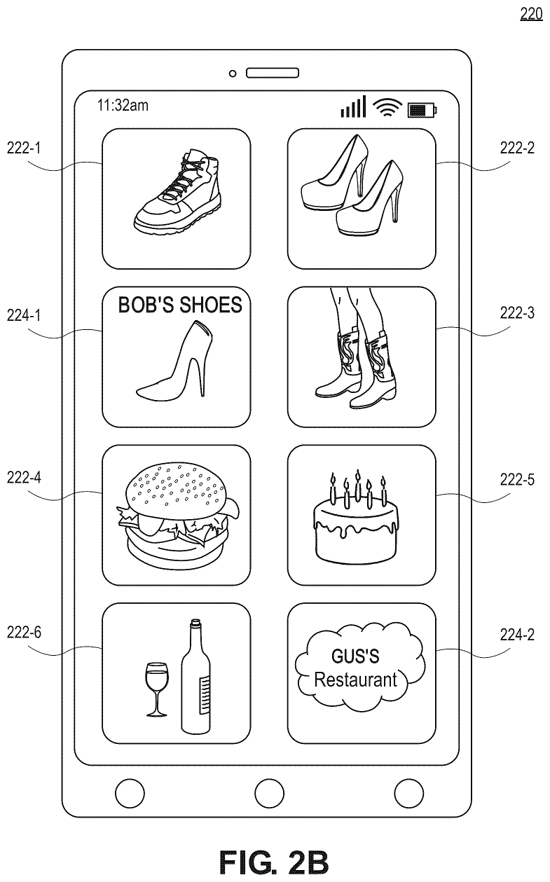

FIG. 3 is an example third party item index generation process 300, according to exemplary implementations of the present disclosure. Some or all of the example process 300 may be performed periodically or on-demand, such as when a third party provides an item catalog or agrees to receive bids with included content item recommendations. Likewise, in some implementations different aspects of the example process 300 may be performed without performing all aspects of the example process 300 and/or other techniques may be utilized to generate content for the third party item index.

The example process 300 begins by adding an item catalog and/or other third party content items received from a third party to the third party item index, as in step 302. For example, a third party may provide the example process with an item catalog listing items, content items, etc., that may be published, posted and/or otherwise presented on the publisher page, as a content item, third party content item, etc. For example, if the publisher is a social networking site, the third party may provide a product catalog identifying items offered for sale by the third party that may be posted or published on publisher pages (e.g., publisher website, publisher application). In some implementations, the item catalog may include any of a variety of information about items included in the item catalog, such as, but not limited to, item description, rating, price, sizes, quantity available for sale, shipping or delivery information, colors, etc. Such information may be included or otherwise referenced in the third party item index and accessible.

In addition to an item catalog received from the third party, in some implementations, other third party item information relating to the third party may also be determined and added to the third party item index, as in 304. For example, the publisher may receive posts and/or other information from other users, such as posts or links to images, content, etc., that originated from the third party. In such an example, the publisher may maintain a data store, such as the content item data store 140 that includes the other third party items posted or added to the provider network, for example by users of the provider network. Likewise, such other third party information may include information about the items that were included when the other third party information that was added, such as the URL from which the item was originally obtained, comments, reviews, pricing, etc.

After obtaining an item catalog from the third party and/or determining other third party information from posts and/or other information provided by other users, the example process 300 may complete, as in 310.

In some implementations, other techniques may also be used to obtain third party item information that is included in the third party item index. For example, third party information that is publicly accessible, for example information presented on a website of the third party, may be accessed and processed to identify third party items and corresponding item information of the third party. For example, if the third party has not yet provided an item catalog, it may be determined that the website of the third party is to be processed to identify third party items so that content item recommendations that are relevant to that third party can be included in bid requests sent to that third party.

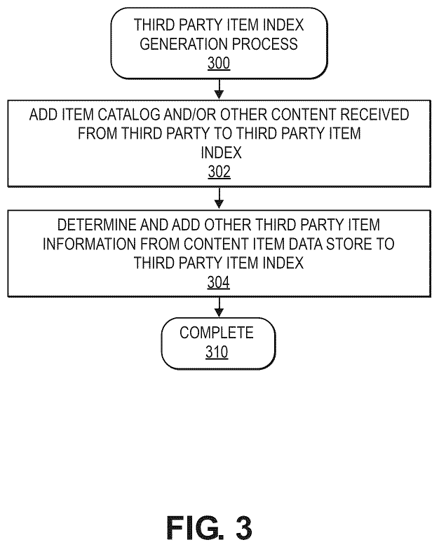

FIG. 4 is an example candidate content item list generation process 400, according to implementations of the present disclosure.

The example process 400 begins at step 402 upon receipt of a request for a third party content item. For example, when a user accesses a publisher page (e.g., website, application), a request for a third party content item may be generated to obtain one or more third party content items to fill one or more content item slots on the page that is to be published to the user.

In response to receipt for a request for a third party content item, the example process may determine one or more third parties for which bid requests that include content item recommendations, determined in accordance with the disclosed implementations, are to be sent, as in step 404. In some implementations, all third parties for which third party information is maintained in the third party item index may be considered as third parties to which a specific bid request is to be sent. In other implementations, an initial processing of the items indicated in the third party item index may be performed to identify items that are potentially relevant to the user and/or the page (e.g., similar content or subject matter as other content items to be presented on the page). In such an example, the example process 400 may only select third parties with items indicated in the third party index that are potentially relevant for generation and delivery of a bid request that includes a content item recommendation specific to that third party.

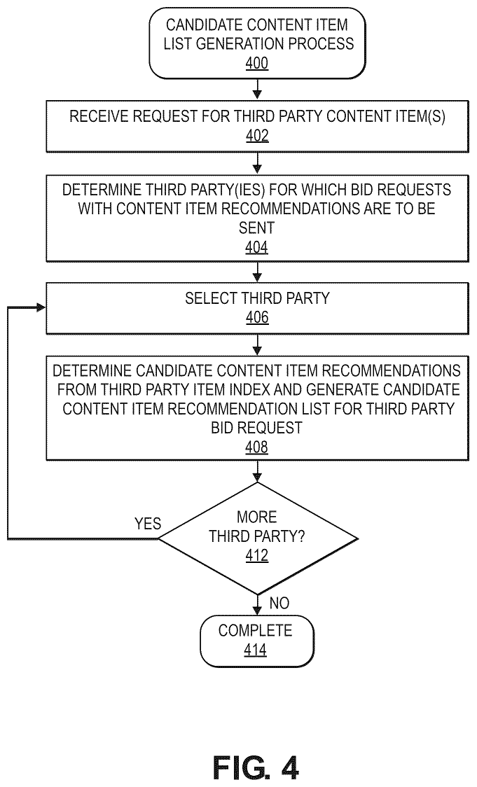

At step 406, a third party of the one or more determined third parties is selected and, at step 408, one or more candidate content item recommendations from the third party item index that correspond to items of the third party are determined and added to a candidate content item recommendation list for that third party. Determination and ranking of content item recommendations is discussed above and further below with respect to FIG. 5. In some implementations, rather than determining an engagement score for each item indicated in the third party item index for that third party, the candidates may be filtered or reduced based on, for example, a potential relevance to the user and/or the subject matter of other content items on the page. The reduced list may then be processed as discussed herein to determine one or more content item recommendations to include in a bid request that is sent to the third party. Still further, in some examples, the overall predicted engagement score determined for the item(s) included in the candidate content item recommendations may be included in the bid request. Alternatively, or in addition thereto, other scores (e.g., predicted conversion, predicted click-through rate, likelihood of winning the bid, etc.) may also be included with the content item recommendation(s) that are specific to that third party and sent with the bid request to that third party.

A determination may then be made as to whether another third party remains for which a candidate content item recommendation list is to be generated, as in step 412. If it is determined that another third party remains for which a candidate content item recommendation list is to be generated remains, the example process 400 returns to step 406, selects a next third party, and continues. If it is determined that no additional third parties remain for which a third party candidate content item recommendation list is to be generated, the example process 400 completes, as in step 414.

FIG. 5 is a block diagram of an exemplary content item recommendation determination model 500, according to exemplary implementations of the present disclosure. Content item recommendation determination model 500 may represent one implementation of content management system 125, shown in FIG. 1.

As shown in FIG. 5, content item recommendation determination model 500 may include candidate quality model 502, candidate contextual model 504, and aggregation function 506. According to exemplary implementations, content item recommendation determination model 500 may include one or more AI systems, or other machine learning models. As illustrated in FIG. 5, content item recommendation determination model 500 may include an AI system with two independent components/towers. Accordingly, the first component/tower of the AI system may be candidate quality model 502, and the second component/tower of the AI system may be candidate contextual model 504.

In connection with a request for third party content items, content item recommendation determination model 500 may obtain, as inputs, candidate quality parameters 512 and candidate contextual parameters 514. Candidate quality parameters 512 may be processed by candidate quality model 502 to determine a candidate quality relevance score for each candidate content item recommendation. Additionally, candidate contextual parameters 514 may be processed by candidate contextual model 504 to determine a candidate contextual relevance score for each candidate content item recommendation. Next, the candidate quality relevance score and the candidate contextual relevance score may be aggregated by aggregation function 506 to determine and output an overall candidate engagement score. According to aspects of the present disclosure, each of the candidate quality relevance score, the candidate contextual relevance score, and the overall candidate engagement score may include a predicted anticipated click-through rate, revenue per recipient, other metrics, and the like for a third party content item selected based on the candidate content item recommendation. Accordingly, the overall candidate engagement score can be utilized to determine which of the candidate content item recommendations to include in a bid request sent to a third party for use in selecting a content item to include in a bid.

In exemplary implementations, candidate quality parameters 512 may be provided as an input to candidate quality model 502 to determine a candidate quality relevance score for each candidate content item recommendation and may include information, parameters, and data associated with the user to whom the third party content item will be presented. For example, candidate quality parameters 512 may include information such as user profile information, user preferences, user browsing history, user tastes, user likes/dislikes, content items associated with the user, demographic information, user activity, user subscriptions, queries performed by the user, and the like. Candidate quality parameters 512 may be provided as inputs to content item recommendation determination model 500 in the form of one or more embedding vectors associated with the user.

Additionally, candidate contextual parameters 514 may be provided as an input to candidate contextual model 504 to determine a candidate contextual relevance score for each candidate content item recommendation, and may include information, parameters, and data associated with the position of the content item to be presented (e.g., slot, column, etc.), information regarding the content items surrounding and/or in close proximity of the slot at which the third party content item is to be presented, information regarding other third party content item(s) surrounding and/or in close proximity of the slot at which the third party content item is to be presented, information regarding the content of the candidate content item recommendation, and the like. Candidate contextual parameters 514 may also include information associated with each candidate content item recommendation, such as content information, format information, additional item information, and the like.

For example, candidate contextual parameters 514 may include one or more embedding vectors associated with content items surrounding and/or in proximity to the predefined content item slot. The embedding vectors may represent certain aspects (e.g., content type, content category, image information, source/location information, content/image features, metadata associated with the content item, etc.) of each surrounding content item, one or more embedding vectors associated with other third party content items surrounding and/or presented in proximity to the predefined content item slot for which a content item is being selected. These embedding vectors may also represent certain aspects (e.g., content item type, content item category, content item format, content item image information, source/location information, content item/image features, metadata associated with the content item, etc.) of the third party content item presented in proximity to the predefined content item slot for which a content item is being selected. Further, the candidate contextual parameters may also include embedding vectors associated with each candidate content item recommendation, which may represent certain aspects (e.g., content type, content category, image information, source/location information, metadata associated with the content item, etc.) of each corresponding candidate content item recommendation.

According to certain aspects of the present disclosure, the embedding vectors associated with the surrounding content items and/or the surrounding other third party content items may be compared with the embedding vectors of each candidate content item recommendation to determine a similarity metric between the surrounding content items and/or the surrounding other third party content items and each candidate content item recommendation. For example, the similarity metric may be determined (e.g., averaging the vectors, utilizing a max pooling algorithm, utilizing a cosine similarity algorithm, utilizing a clustering algorithm, etc.), and the similarity metric may be provided as an input to candidate contextual model 504 to determine a candidate contextual relevance score associated with each candidate content item recommendation.

As shown in FIG. 5, the candidate quality relevance score and the candidate contextual relevance score may be provided to aggregation function 506, which may combine and/or aggregate the candidate quality relevance score and the candidate contextual relevance score to determine an overall candidate engagement score for each candidate content item recommendation. For example, a Sigmoid function may be applied to the combination of the candidate quality relevance score and the candidate contextual relevance score to determine the overall candidate engagement score for each candidate content item recommendation. The overall candidate engagement score may represent a predicted click-through rate, revenue per recipient, or other metric based on both the candidate quality information and the localized contextual information. Accordingly, the candidate content item recommendation with the highest overall candidate engagement score for each predefined content item slot may be selected for inclusion in a bid request sent to the third party for use by the third party in selecting a third party content item for a bid in response to the bid request.

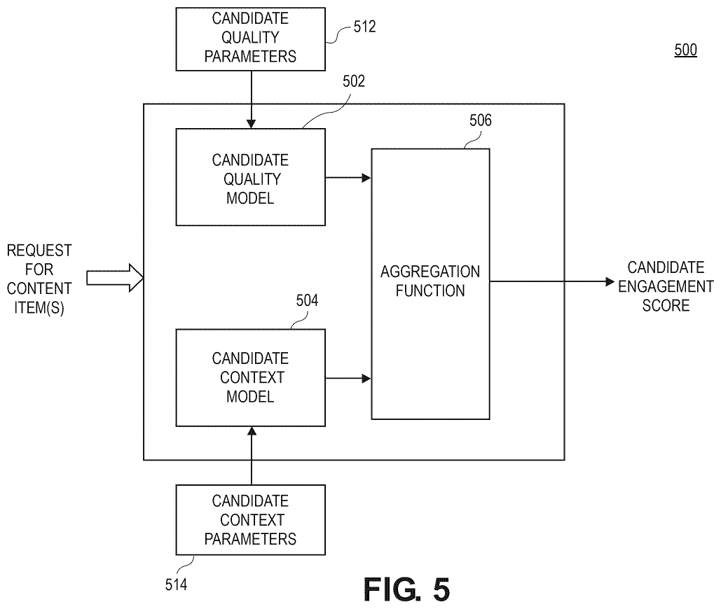

FIG. 6 is a flow diagram of an exemplary training process 600 for training an example machine learning (“ML”) model, such as a convolutional neural network (“CNN”), according to exemplary implementations of the present disclosure.

As shown in FIG. 6, training process 600 is configured to train an untrained ML model 634 operating on computer system 640 to transform untrained ML model 634 into trained ML model 636 that operates on the same or another computer system, such as remote computing resource 120. In the course of training, as shown in FIG. 6, at step 602, untrained ML model 634 is initialized with training criteria 630. Training criteria 630 may include, but is not limited to, information as to a type of training, and number of layers to be trained, etc. According to implementations of the present disclosure, the trained ML model 636 may be trained to include two independent components/towers in a single trained ML model 636. Accordingly, the two components/towers of trained ML model 636 may be co-trained together in a single trained ML model 636.

At step 604 of training process 600, a corpus of training data 632, may be accessed. For example, if training is to generate a trained ML model that predicts candidate content item recommendation relevance scores, also referred to herein as overall engagement scores, training data 632 may include candidate quality associated data such as user profile information, user preferences, user browsing history, user tastes, user likes/dislikes, content items associated with the user, demographic information, user activity, user subscriptions, queries performed by the user, and the like, as well as candidate contextual data, such as data associated with the position at which the third party content item is to be presented (e.g., slot, column, etc.), information regarding other content items surrounding and/or in close proximity of the position at which the third party content item is to be presented (e.g., embedding vectors, etc.), information regarding other third party content items surrounding and/or in close proximity of the position at which the third party content item is to be presented (e.g., embedding vectors, etc.), information regarding the content of the candidate content item recommendation (e.g., embedding vectors, etc.), and the like.

With training data 632 accessed, at step 606, training data 632 is divided into training and validation sets. Generally speaking, the items of data in the training set are used to train untrained ML model 634 and the items of data in the validation set are used to validate the training of the ML model. As those skilled in the art will appreciate, and as described below in regard to much of the remainder of training process 600, there are numerous iterations of training and validation that occur during the training of the ML model.

At step 608 of training process 600, the data items of the training set are processed, often in an iterative manner. Processing the data items of the training set includes capturing the processed results. After processing the items of the training set, at step 610, the aggregated results of processing the training set are evaluated, and at step 612, a determination is made as to whether a desired accuracy level has been achieved. If the desired accuracy level is not achieved, in step 614, aspects of the machine learning model are updated in an effort to guide the machine learning model to generate more accurate results, and processing returns to step 606, where a new set of training data is selected, and the process repeats. Alternatively, if the desired accuracy level is achieved, training process 600 advances to step 616.

At step 616, and much like step 608, the data items of the validation set are processed, and at step 618, the processing accuracy of this validation set is aggregated and evaluated. At step 620, a determination is made as to whether a desired accuracy level, in processing the validation set, has been achieved. If the desired accuracy level is not achieved, in step 614, aspects of the machine learning model are updated in an effort to guide the machine learning model to generate more accurate results, and processing returns to step 606. Alternatively, if the desired accuracy level is achieved, the training process 600 advances to step 622.

At step 622, the two independent components/towers of the ML model are split, and at step 624, a finalized, trained ML model 636 is generated. Typically, though not exclusively, as part of finalizing the now-trained ML model 636, portions of the ML model that are included in the model during training for training purposes are extracted, thereby generating a more efficient trained ML model 636.

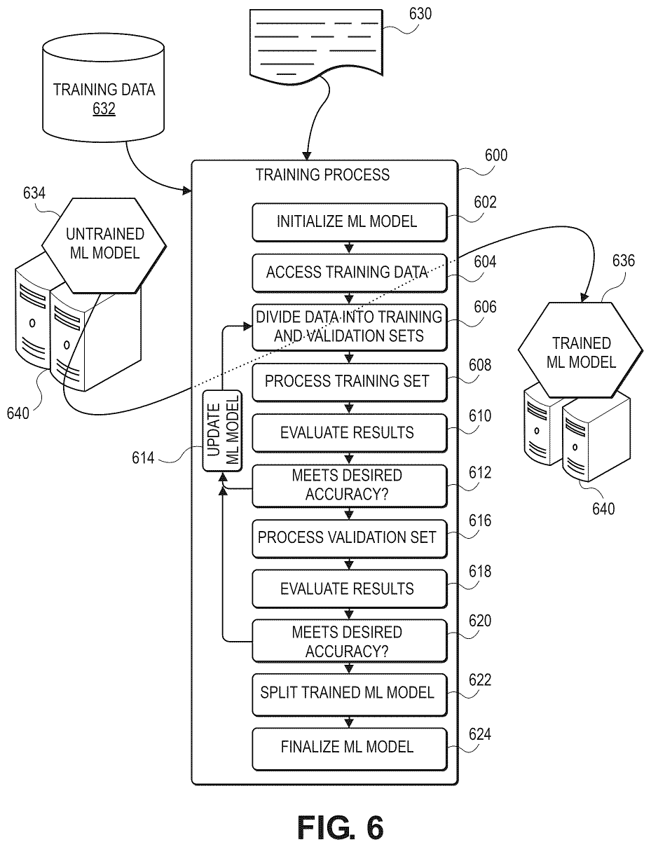

FIG. 7 is a flow diagram of an exemplary content item recommendation determination process 700, according to exemplary implementations of the present disclosure.

As shown in FIG. 7, process 700 may begin with a request for one or more third party content items, as in step 702. The request for third party content items may be obtained, for example, in connection with a user who is making a query, navigating, viewing, accessing, and/or otherwise consuming content items as part of a social media platform or environment, a networking platform or environment, an e-commerce platform or environment, or through any other form of interactive computing. In response to the request for third party content items, in step 703 a third party is selected to which a bid request is to be sent. Any of a variety of known techniques may be utilized to select third parties. Upon selection of a third party, at step 704, available candidate content item recommendations corresponding to the selected third party may be obtained. For example, candidate content item recommendations may be determined from the third party item index maintained for the selected third party (third party item index data store 161).

In step 706, candidate quality parameters may be determined. For example, the candidate quality parameters may include information such as a query submitted by the user, user profile information, user preferences, user browsing history, user tastes, user likes/dislikes, content items associated with the user, demographic information, user activity, user subscriptions, queries performed by the user, and the like. The candidate quality parameters can be provided as an input to a trained AI system, which can process the candidate quality parameters to determine a candidate quality relevance score for each candidate content item recommendation, as in step 708. The predicted candidate quality relevance score may represent a predicted click-through rate, revenue per recipient, or other metric based on the user information.

In step 710, candidate contextual parameters may be obtained. For example, the candidate contextual parameters may include information such as the position at which the third party content item is to be presented, information regarding the content items surrounding and/or in close proximity of the position at which the third party content item to be presented, information regarding other third party content items surrounding and/or in close proximity to the position at which the third content item is to be presented, information regarding the content of the candidate content item recommendation, and the like. According to certain aspects, rather than obtain candidate contextual parameters and information associated with the other content items, cached content items may be utilized as an approximation of the other content items so as to reduce latency issues, and the candidate contextual parameters provided to the trained AI system may include information associated with the cached content items. Additionally, the candidate contextual parameters may include a similarity metric representing a similarity between the surrounding content items and/or the surrounding other third party content items and each candidate content item recommendation. For example, the similarity metric may be determined based on embedding vectors associated with the surrounding content items and/or the surrounding other third party content items and each candidate content item recommendation. For example, the similarity metric may be determined (e.g., averaging the vectors, utilizing a max pooling algorithm, utilizing a cosine similarity algorithm, utilizing a clustering algorithm, etc.).

The candidate contextual parameters can also be provided to the trained AI system, which can process the candidate contextual parameters to determine a candidate contextual relevance score for each candidate content item recommendation, as in step 712. The candidate contextual relevance score may represent a predicted click-through rate, revenue per recipient, or other metric based on the localized contextual information.

In step 714, the candidate quality relevance score and the candidate contextual relevance score may be combined and/or aggregated to determine an overall candidate engagement score for each candidate content item recommendation. For example, a Sigmoid function may be applied to the combination of the predicted candidate quality relevance score and the predicted candidate contextual relevance score to determine the predicted overall candidate engagement score for each candidate content item recommendation. The overall candidate engagement score may represent a relevance and/or a likelihood of user engagement with a third party content item selected based on the candidate content item recommendation, and may include a predicted click-through rate, revenue per recipient, or other metric based on both the candidate quality information and the localized contextual information, and may be used to select one or more candidate content item recommendations specific to the selected third party to include in a bid request sent to that selected third party, as in step 716. For example, the candidate content item recommendation(s) with the highest overall candidate engagement score(s) may be selected as the content item recommendation(s) to be included in a bid request that is to be sent to the selected third party.

At step 718, a bid request for the selected third party may be generated that includes the candidate content item recommendation(s) with the highest overall candidate engagement score(s) and does not include any user information about the user to which the third party content item may be presented and that bid request sent to the selected third party. At step 720, a determination may be made as to whether there is an additional third party for which a bid request with a content item recommendation corresponding to that third party is to be generated and sent. If it is determined at step 720 that there is an additional third party, the example process 700 returns to block 703, selects the next third party, and continues.

While the example process 700 illustrates steps 704 through 718 being performed serially for each third party, it will be appreciated that the steps 704 through 718 may be performed in parallel for each third party such that bid requests with content item recommendations specific to each third party are generated and sent to those third parties at step 718 concurrently.

If it is determined at step 720 that there are no additional third parties remaining for which a bid request with a content item recommendation for that third party is to be included, and after the bid requests have been sent, bids from one or more of the third parties are received, as in step 722. As discussed above, in some instances, the bid may be for the same product, third party content item, or other item included in the content item recommendation of the bid request. In other examples, the bid may indicate a different third party content item, that may or may not have been selected by the third party based on the content item recommendation included in the bid request. As such, the content item recommendation is just that, a recommendation that the third party may consider or disregard. For example, if the content item recommendation is for a specific product offered by that third party, the third party may utilize that content item recommendation to select a related product, a substitute product, a complimentary product (or disregard the content item recommendation) and send a bid back corresponding to a third party content item selected by the third party.

At step 724, one or more winning bids are selected by the example process 700 and the third party content item(s) corresponding to the selected winning bid(s) is presented in the content item slot(s) to the user, as in step 726. Selection of a winning bid(s) may follow any desired selection technique. For example, a highest bid(s) may be selected as the winning bid(s). In other implementations, other techniques may be utilized to select a winning bid(s).

Optionally, after the third party content item(s) has been selected and presented to the user, the performance of the presented third party content item may be obtained, as in step 728. For example, click through rates associated with the third party content item may be determined, and in step 730, based on the tracked performance (e.g., click through rates), feedback training data may be generated to continuously update the trained AI system, such as the trained ML model discussed herein, to improve the performance and accuracy of the trained AI system. Finally, the example process 700 completes at step 732.

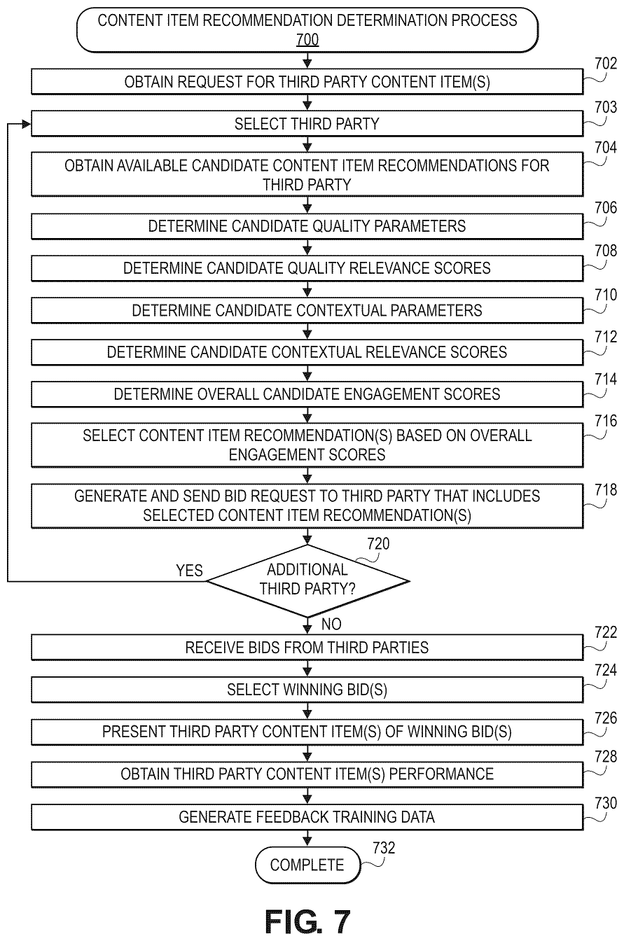

FIG. 8 is a flow diagram of an exemplary machine learning model update process 800, according to exemplary implementations of the present disclosure.

As discussed above, in some implementations, the ML model used to determine content item recommendations may be continually or periodically updated as performance of third party content items selected based on the determined content item recommendations are tracked and/or monitored. Process 800 may begin by initially training an ML model to determine content item recommendations to include in bid requests sent to third parties, as in step 802. This is described in further detail herein in connection with FIG. 6.

At some point after the ML model is initially trained, the performance of one or more third party content items selected based on determined content item recommendations may be obtained (e.g., based on user interactions with the third party content items—click through rates, revenue per response, etc.), as in 804.

The performance of the one or more third party content items selected based on the determined content item recommendations may be utilized to generate feedback training data, which may be used to update the ML model, as in 806.

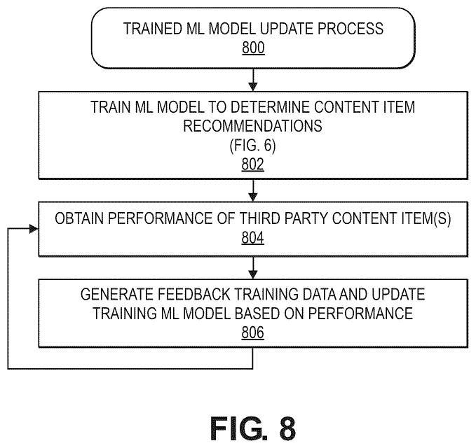

FIG. 9 illustrates an exemplary client device 900 that can be used in accordance with various implementations described herein. In this example, client device 900 includes display 902 and optionally at least one input component 904, such as a camera, on a same side and/or opposite side of the device as display 902. Client device 900 may also include an audio transducer, such as speaker 906, and microphone 908. Generally, client device 900 may have any form of input/output components that allow a user to interact with client device 900. For example, the various input components for enabling user interaction with the device may include touch-based display 902 (e.g., resistive, capacitive, Interpolating Force-Sensitive Resistance (IFSR)), camera (for gesture tracking, etc.), microphone, global positioning system (GPS), compass or any combination thereof. One or more of these input components may be included on a user device or otherwise in communication with the user device. Various other input components and combinations of input components can be used as well within the scope of the various implementations, as should be apparent in light of the teachings and suggestions contained herein.

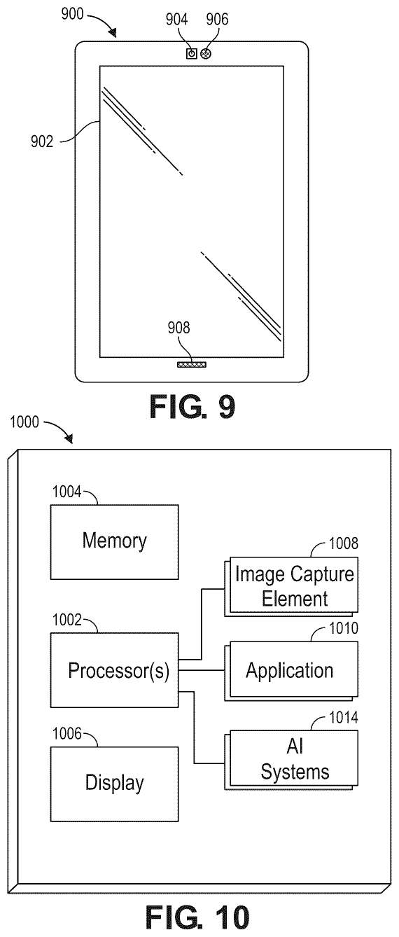

In order to provide the various functionality described herein, FIG. 10 illustrates an exemplary set of components 1000 of client device 900, such as client device 900 described with respect to FIG. 9 and discussed herein. In this example, the device includes at least one central processor 1002 for executing instructions that can be stored in at least one memory device or element 1004. As would be apparent to one of ordinary skill in the art, the device can include many types of memory, data storage or computer-readable storage media, such as a first data storage for program instructions for execution by the one or more processors 1002. Removable storage memory can be available for sharing information with other devices, etc. The device typically will include some type of display 1006, such as a touch-based display, electronic ink (e-ink), organic light emitting diode (OLED), liquid crystal display (LCD), etc.

As discussed, the device in many implementations will include at least one image capture element 1008, such as one or more cameras that are able to image objects in the vicinity of the device. An image capture element can include, or be based at least in part upon, any appropriate technology, such as a CCD or CMOS image capture element having a determined resolution, focal range, viewable area, and capture rate. The device can include at least one application component 1010 for performing the implementations discussed herein. Optionally, the device can include trained AI systems 1014, which can be configured to determine content item recommendations to include in bid requests sent to third parties requesting bids for presentation of third party content items to a user according to the implementations described herein. The user device may be in constant or intermittent communication with one or more remote computing resources and may exchange information, such as livestream feeds, chat messages, etc., with the remote computing system(s) as part of the disclosed implementations.

The device also can include at least one location component, such as GPS, NFC location tracking, Wi-Fi location monitoring, etc. The example client may also include at least one additional input device able to receive conventional input from a user. This conventional input can include, for example, a push button, touch pad item, touch-based display, wheel, joystick, keyboard, mouse, trackball, pointer, or any other such device or element whereby a user can submit an input to the device. These I/O devices could be connected by a wireless, infrared, Bluetooth, or other link as well in some implementations. In some implementations, however, such a device might not include any buttons at all and might be controlled only through touch inputs (e.g., touch-based display), audio inputs (e.g., spoken), or a combination thereof.

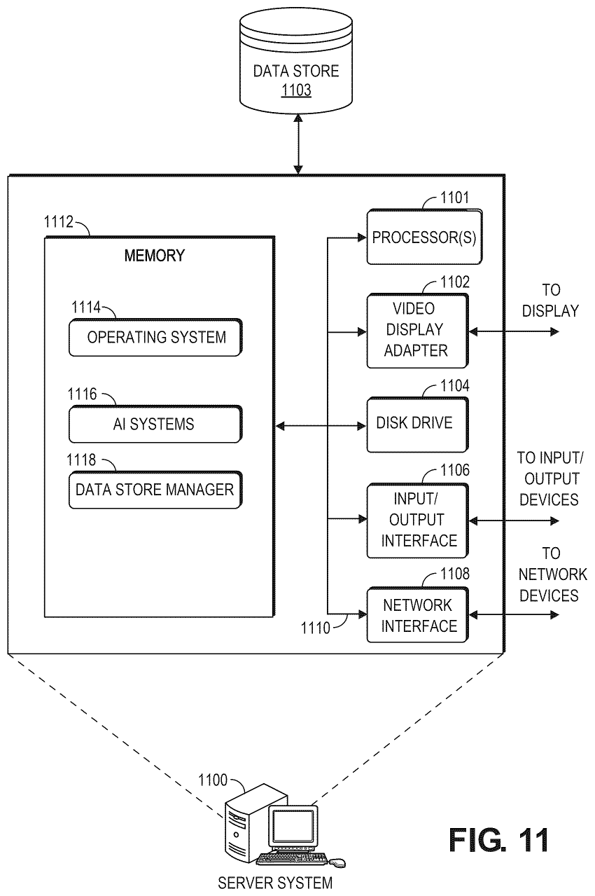

FIG. 11 is a pictorial diagram of an illustrative implementation remote computing resource 1100 that may be used with one or more of the implementations described herein. Remote computing resource 1100 may include one or more processors 1101, such as one or more redundant processors, video display adapter 1102, disk drive 1104, input/output interface 1106, network interface 1108, and memory 1112. Processor(s) 1101, video display adapter 1102, disk drive 1104, input/output interface 1106, network interface 1108, and memory 1112 may be communicatively coupled to each other by communication bus 1110.

Video display adapter 1102 provides display signals to a local display permitting an operator of remote computing resource 1100 to monitor and configure operation of remote computing resource 1100. Input/output interface 1106 likewise communicates with external input/output devices not shown in FIG. 11, such as a mouse, keyboard, scanner, or other input and output devices that can be operated by an operator of remote computing resource 1100. Network interface 1108 includes hardware, software, or any combination thereof, to communicate with other computing devices. For example, network interface 1108 may be configured to provide communications between remote computing resource 1100 and other computing devices, such as client device 900.

Memory 1112 generally comprises random access memory (RAM), read-only memory (ROM), flash memory, and/or other volatile or permanent memory. Memory 1112 is shown storing operating system 1114 for controlling the operation of remote computing resource 1100. Remote computing resource 1100 may also include trained AI systems 1116, as discussed herein. In some implementations, trained AI systems 1116 may determine content item recommendations to be included in a bid request set to third parties requesting bids for placement and presentation of third party content items to a user at predefined content item slots. In other implementations, trained AI systems 1116 may exist on both remote computing resource 1100 and/or each client device (e.g., AI systems 1014).

Memory 1112 additionally stores program code and data for providing network services that allow client devices 110 and external sources to exchange information and data files with remote computing resource 1100. Memory 1112 may also include interactive trained AI system 1116, which may communicate with data store manager application 1118 to facilitate data exchange and mapping between the data store 1103, user/client devices, such as client devices 110, external sources, etc.

As used herein, the term “data store” refers to any device or combination of devices capable of storing, accessing and retrieving data, which may include any combination and number of data servers, databases, data storage devices and data storage media, in any standard, distributed or clustered environment. Remote computing resource 1100 can include any appropriate hardware and software for integrating with the data store 1103 as needed to execute aspects of one or more applications for the client device 900, the external sources, etc.

Data store 1103 can include several separate data tables, databases or other data storage mechanisms and media for storing data relating to a particular aspect. For example, data store 1103 as illustrated includes digital items (e.g., images) and corresponding metadata (e.g., image segments, popularity, source) about those items. As discussed with respect to FIG. 1, the data stores may also store user information, such as user history, candidate content items, third party item indexes, etc.

It should be understood that there can be many other aspects that may be stored in data store 1103, which can be stored in any of the above listed mechanisms as appropriate or in additional mechanisms of any of the data store. Data store 1103 may be operable, through logic associated therewith, to receive instructions from remote computing resource 1100 and obtain, update or otherwise process data in response thereto.

Remote computing resource 1100, in one implementation, is a distributed environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 11. Thus, the depiction in FIG. 11 should be taken as being illustrative in nature and not limiting to the scope of the disclosure.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

Moreover, with respect to the one or more methods or processes of the present disclosure shown or described herein, including but not limited to the flow charts shown in FIGS. 3-8, orders in which such methods or processes are presented are not intended to be construed as any limitation on the claims, and any number of the method or process steps or boxes described herein can be combined in any order and/or in parallel to implement the methods or processes described herein. In addition, some process steps or boxes may be optional. Also, the drawings herein are not drawn to scale.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
determining, at a content management system, that a third party content item is to be included in a content item slot of a page and presented to a user as part of a presentation of the page;
determining, at the content management system, a third party to which a bid request is to be sent to request a bid for placement of a third party content item at the content item slot;
determining, at the content management system and based at least in part on at least one of user information about the user or contextual information about the page, a product of the third party;
including, at the content management system, an indication of the product in a first bid request as a first content item recommendation for a first third party content item for which a first bid is to be submitted by the third party in response to the first bid request;
sending, from the content management system and to the third party, the first bid request including the first content item recommendation, wherein the first bid request and the first content item recommendation do not include any of the user information;
receiving, at the content management system, from the third party and in response to the first bid request, a first bid for presentation of the first third party content item at the content item slot; and
presenting, at the content item slot and to the user, the first third party content item.

2. The computer-implemented method of claim 1, further comprising:
determining, at the content management system, a second third party to which a second bid request is to be sent to request a second bid for placement of a second third party content item at the content item slot;
determining, at the content management system and based at least in part on at least one of the user information or the contextual information, a second product of the second third party;
including, at the content management system, a second indication of the second product in the second bid request as a second content item recommendation for a second third party content item to be submitted by the second third party in response to the second bid request;
sending, from the content management system and to the second third party, the second bid request including the second content item recommendation, wherein the second bid request and the second content item recommendation do not include any of the user information;
receiving, at the content management system, from the second third party, and in response to the second bid request, a second bid for presentation of the second third party content item at the content item slot; and
determining, at the content management system, that the first bid request is a winning bid request.

3. The computer-implemented method of claim 1, wherein determining the product of the third party, further includes:
obtaining a plurality of candidate content item recommendations corresponding to the third party;
obtaining a plurality of candidate quality parameters;
obtaining a plurality of candidate contextual parameters;
for each of the plurality of candidate content item recommendations:
processing, using a trained machine learning model (“ML model”), at least a portion of the plurality of candidate quality parameters to generate a predicted candidate quality relevance score for the candidate content item recommendation;
processing, using the trained ML model, at least a portion of the plurality of candidate contextual parameters to generate a predicted candidate contextual relevance score for the candidate content item recommendations; and
aggregating the predicted candidate quality relevance score and predicted candidate contextual relevance score to generate a predicted overall candidate engagement score for the candidate content item recommendation; and
determining, based at least in part on the predicted overall candidate engagement scores for each of the plurality of candidate content item recommendations, the first content item recommendation from the plurality of candidate content item recommendations to be included in the first bid request.

4. The computer-implemented method of claim 3, wherein the plurality of candidate contextual parameters includes at least one of:
a first parameter associated with a position of the content item slot at which the first third party content item is to be presented; or
a second parameter associated with a content item that is to be presented proximate to the position.

5. The computer-implemented method of claim 1, wherein determining the product of the third party, includes:
accessing a third party item index that includes information about a plurality of products associated with the third party.

6. The computer-implemented method of claim 5, wherein at least some of the information about the plurality of products is provided by the third party as part of a product catalog.

7. A computing system, comprising:
one or more processors; and
a memory storing program instructions that, when executed by the one or more processors, cause the one or more processors to at least:
determine that a third party content item is to be included in a content item slot and presented to a user;
determine, based at least in part on at least one of user information about a user to which the third party content item is to be presented or contextual information about a page that includes the content item slot, a content item recommendation to be included in a bid request sent to a third party, the content item recommendation specific to the third party;
send, to the third party, the bid request and the content item recommendation;
receive, from the third party and responsive to the bid request, a bid to present a third party content item at the content item slot, wherein the third party content item is determined by the third party based at least in part on the content item recommendation; and
present the third party content item at the content item slot and to the user.

8. The computing system of claim 7, wherein the content item recommendation indicates at least one of a product of the third party, the third party content item, or a second third party content item.

9. The computing system of claim 8, wherein the program instructions that, when executed by the one or more processors to determine the content item recommendation, further include program instructions that, when executed by the one or more processors, further cause the one or more processors to at least:
determine a plurality of candidate content item recommendations specific to the third party; and
select the content item recommendation from the plurality of candidate content item recommendations based at least in part on the user information.

10. The computing system of claim 9, wherein the plurality of candidate content item recommendations are obtained from a third party item index maintained by the computing system, the third party item index indicating at least a plurality of products of the third party.

11. The computing system of claim 7, wherein the program instructions that, when executed by the one or more processors, further cause the one or more processors to at least:
determine a plurality of products of the third party;
generate a third party item index that includes item information corresponding to the plurality of products; and
wherein the program instructions that cause the one or more processors to determine the content item recommendation further include instructions that, when executed by the one or more processors, further cause the one or more processors to at least:
determine, based at least in part on the third party item index, a plurality of candidate content item recommendations; and
determine, from the plurality of candidate content item recommendations and based at least in part on the user information, the content item recommendation included in the bid request.

12. The computing system of claim 11, wherein the program instructions that cause the one or more processors to determine the plurality of products, further include program instructions that, when executed by the one or more processors, further cause the one or more processors to at least:
receive, from the third party, an item catalog indicating at least some of the plurality of products; and
update the third party item index to include products indicated in the item catalog.

13. The computing system of claim 11, wherein the program instructions that cause the one or more processors to determine the plurality of products, further include program instructions that, when executed by the one or more processors, further cause the one or more processors to at least:
receive, from a second user, an indication of a first product associated with the third party; and
update the third party item index to include the indication of the first product.

14. The computing system of claim 11, wherein the program instructions that cause the one or more processors to determine the plurality of products, further include program instructions that, when executed by the one or more processors, further cause the one or more processors to at least:
process at least one page of a website of the third party to determine a first product of the plurality of products; and
update the third party item index to include an indication of the first product.

15. The computing system of claim 7, wherein the program instructions that cause the one or more processors to determine the content item recommendation, further include program instructions that, when executed by the one or more processors, further cause the one or more processors to at least:
determine, based at least in part on the user information and content information of other content items to be presented to the user, the content item recommendation.

16. A method, comprising:
determining a third party to which a bid request is to be sent to request a bid for placement of a third party content item at a content item slot of a page that is to be presented to a user;
determining, based at least in part on at least one of user information about the user or contextual information about the page, a content item recommendation that is specific to the third party;
sending, to the third party, a first bid request and content item recommendation, without sending to the third party the user information;
receiving, from the third party and in response to the bid request, a bid for placement of a third party content item, wherein the third party content item is determined by the third party based at least in part on the content item recommendation; and
presenting the third party content item at the content item slot and to the user.

17. The method of claim 16, further comprising:
determining a second third party to which a second bid request is to be sent to request a second bid for placement of a second third party content item at the content item slot;
determining, based at least in part on the user information, a second content item recommendation that is specific to the second third party;
sending, to the second third party, the second bid request and the second content item recommendation;
receiving, from the second third party and in response to the second bid request, a second bid for placement of a second third party content item; and
determining that the bid is a winning bid; and
wherein presenting the third party content item is responsive to determining that the bid is the winning bid.

18. The method of claim 16, further comprising:
obtaining a plurality of candidate content item recommendations, each of the plurality of candidate content item recommendations specific to the third party; and
determining, based at least in part on the user information, the content item recommendation from the plurality of candidate content item recommendations.

19. The method of claim 18, wherein the content item recommendation is determined based at least in part on the user information and information about a content item to be presented concurrent with the third party content item.

20. The method of claim 16, further comprising:
monitoring an actual performance associated with a presentation of the third party content item at the content item slot;
generating, based at least in part on the actual performance associated with the presentation of the third party content item, feedback training data; and
providing the feedback training data as a training input to update an artificial intelligence system that is used to determine the content item recommendation.
